(19) United States
(12) Patent Application Publication
(10) Pub. No.: US 2016/0298726 A1
(43) Pub. Date: Oct. 13, 2016

(54) CONTINUOUS FORCE-TRANSMISSION BELT AND PROCESS FOR THE PRODUCTION THEREOF

(71) Applicant: ARNTZ BETEILIGUNGS GMBH & CO. KG, Höxter (DE)

(72) Inventors: Salem HAZIM, Hoexter (DE); Florian LOTZ, Brevoerde (DE)

(21) Appl. No.: 15/064,098

(22) PCT Filed: Sep. 9, 2014
(86) PCT No.: PCT/DE2014/000466

§ 371 Date: Jun. 9, 2016

(30) Foreign Application Priority Data
Sep. 12, 2013 (DE) 10 2013 015 047.7

(51) Int. Cl. F16G 5/06; B29D 29/10; F16G 5/20

(52) U.S. Cl. CPC F16G 5/06; F16G 5/20; B29D 29/103; B29K 2011/00; B29K 2313/00

(57) ABSTRACT

The endless force-transmission belt in the form of a V-belt or ribbed V-belt having low-elasticity tensile members is produced in a molding process, in which a tubular blank having at least two belt material layers and a layer of tensile members is first built up and in a subsequent step is molded in a profiling drum under heat and pressure against the profile of the drum. Here a layer, initially applied to the rear side of the belt behind the tensile member layer, is pressed out of the belt material arranged on the rear side and through the tensile member layer under pressure and heat during the molding process, in order to form both the tensile member embedment and a part of the belt body in the finished belt.

The invention relates to a process for producing an endless force-transmission belt in the form of a V-belt or ribbed V-belt and to the force-transmission belt produced in this way.

Endless force-transmission belts basically comprise a belt back, remote from the force-transmission side, and a belt body on which a force-transmission zone is formed. For this purpose, the belt body may be of a wedge-shaped formation or may comprise a plurality of ribs. The selected profile is precisely matched to the belt pulley accommodating the belt. The force is transmitted primarily via the flanks of the wedge or the ribs. Reinforcing members or tensile members, which may comprise individual strands or cords or also flat structures, are usually arranged between the belt body and the belt back. Various tensile member materials are used, including steel, glass, carbon fibers, synthetic fibers and natural fibers. If elastic tensile members are required, polyester or polyamide tensile members are often used. The main bodies are usually composed of elastomer materials; in some cases, thermoplastics are also used. The belt back is likewise usually composed of elastomer materials or thermoplastics. Both belt backs and main bodies may be built up in multiple layers and have outer covering layers. For many applications textile overlays and/or film overlays are used both on the force-transmission side and on the rear side of the belt. The tensile members are often situated in a separate embedding material, which is intended to fully enclose the tensile members and to anchor them in the belt. The embedding material may be an elastomer material, a thermoplastic or also a resin. It is essential that the possibly diverse materials for the belt back, embedment and belt body combine well with one another, in order to prevent the belt failing under load.

For many applications tensile members are desirable which are less elastic and which stretch as little as possible. For these applications so-called “high modulus reinforcing members” have been developed. The elasticity of these high modulus reinforcing members is very low. Examples of high modulus cords are those of carbon, glass, steel or aramid.

### PRODUCTION PROCESSES IN THE STATE OF THE ART

Endless force-transmission belts having profiled force-transmission zones can basically be produced in various ways. As a rule, tubular blanks are first made, which are then cut into the individual, annular endless belts. It is also possible to produce the belts from a band-shaped material, which is finally joined together to form the endless belt, although this produces a seam, which is often undesirable. The invention therefore relates exclusively to endless belts which are obtained from tubular blanks.

The required profile on the force-transmission side may basically be formed on the blank in two different ways: either by an abrasive process or by a molding process. In the abrasive process the profile is cut out from a sufficiently thick layer; in the molding process the profile is impressed into the layer provided for the belt body under heat and pressure.

The blank, which here is intended for further processing by a molding process, is produced as follows:

One or more layers for the subsequent belt back are first applied to a so-called belt building drum. Reinforcing members or tensile members are then applied around this layer or layers. In the case of stranded tensile members, these are preferably wound, that is to say carried spirally around the belt back layers. Flat reinforcing members may be wound off from a reel and laid in one or more layers around the predefined belt back layers. After applying the tensile member layer, the one or more layers for the belt body are applied. The blank therefore contains all the necessary materials. This blank is also referred to as a fabrication reel. Molding is then undertaken. Finally, the individual belts are separated. For the belt elastomers the blank often contains rubber layers, which in the molding process are vulcanized in the heat. Other elastomer materials may also be provided, however, for example thermoplastic elastomers. Specific thermoplastics may also be used as belt materials for special applications.

The blank is then taken off the belt building drum and introduced into a heatable autoclave drum for molding and possibly vulcanization. Here, on its inside wall, the drum-shaped autoclave has a profile which is impressed into the outside wall of the tubular blank. Here the required pressure is applied to the inside wall of the tubular blank from the inside of the drum by means of a bellows acting via an expandable sleeve. The tubular blank is pressed radially outwards against the wall of the vulcanization and molding autoclave, so that the profile can impress itself. This necessitates a circumferential or diametric enlargement of the blank.

If the pressure from inside is applied pneumatically by a bellows, this is also referred to as an “airbag process”.

It will be clear from the preceding description of the airbag process that it is only capable of processing tensile members which have a certain inherent elasticity, for example polyester or polyamide fiber cords. Such elastic synthetic fiber cords are capable of undergoing the required circumferential stretching of the tubular blank in the impressing process. The stretching is necessary in order for the cords to achieve the correct cord position in the impressing phase. In fabricating the blank on the belt building drum, the elastic cords do not yet lie in the correct final position. The circumference of the blank and its diameter are smaller than in the impressed product. Only during the impressing phase in the vulcanizing autoclave are they pressed or stretched into the correct final position by the sleeve pressure. The stretching of high modulus cords, and of less elastic or non-elastic materials in general, is too low for the airbag molding process to achieve the correct cord position in the end product. An adequate stretching is not possible through sleeve pressure.

The useful and economic production of belts with high modulus cords has hitherto been possible only by the Auma and abrasive processes. Production by the molding process would nevertheless afford various advantages. Firstly, the saving in materials in the molding process is up to 30% compared to an abrasive process. The saving is particularly marked in the case of coarse profile grooves. Ground belts always exhibit an early local maximum on the slip/power diagram. Belts that have been produced by the airbag molding process do not exhibit this disadvantage and at the same time have a high mileage with a high performance right to the end (less slip).

A molding process for belts with low-elasticity tensile members, such as, in particular, high modulus tensile members, would therefore be very advantageous.

DT 26 43 529 A1 already addresses the production molding of a drive belt having low-elasticity staple length reinforcements. Such staple length tensile parts would have the unwanted tendency to buckling if crosslinking should occur between a core and an elastomer air sack or bubble, which might be located around the belt sleeve. DT 26 43 529 A1 therefore proposes that an outwardly directed and an inwardly directed pressure be simultaneously exerted on the belt blank whilst the vulcanization and the molding are being performed. The tensile parts are thereby held in place and at the same time under tension during the molding and crosslinking of the still free-flowing or plastic vulcanizing rubber material. The molding occurs around the tensile members, which are themselves not basically stretched.

The process according to DT 26 43 529 A1 demands a very precise matching of the various pressures and a precise positioning of the materials in the mold. The process is thereby relatively intricate. The counter-pressure produces an extensive pressure equilibrium, so that the tensile members are held only under slight pressure, if any. This sometimes gives rise to production inaccuracies, which can result from slight pressure shifts outwards or inwards.

The object of the invention is therefore to provide a new shaping process for the production of endless force-transmission belts having low-elasticity tensile members and in so doing to largely avoid the disadvantages in the state of the art, and to allow new, interesting belt products having high modulus tensile members.

The object is achieved by means of the process as claimed in claim 1 and the endless force-transmission belt as claimed in claim 8.

The process according to the invention as claimed in claim 1 represents a molding process, in particular an airbag molding process, for producing a profiled endless belt, preferably in the form of a V-belt or ribbed V-belt, which results in belts having low-elasticity tensile members and excellent running and reliability characteristics. The tubular blank for the process comprises at least two belt material layers and a layer of tensile members between these two belt material layers. The structure of the blank from the outside (profile side) to the inside (rear side of the belt) is as follows:
a) a layer of a belt material (M1) for the outermost rib-side belt profile zone of the belt body,
b) a layer of low-elasticity tensile members,
c) a layer of a belt material (M2), which under the molding conditions has a viscosity sufficient to press the belt material (M2) through the spaces between the tensile members and in the process to form a tensile member embedment.

According to the invention the belt material (M2) is present in the blank in such a quantity and during molding is pressed through to such an extent that after the molding operation some of the belt material (M2) forms a belt body area inside the wedge or the ribs. The tensile member embedment and the belt body area, which is formed from the layer of M2 pressed through, form a unified zone with no interface.

One characteristic of the process according to the invention is that the material (M2) from a layer of material in the blank, initially arranged on the rear side of the belt, is pressed partially and preferably to a considerable extent through the tensile member layer, so that it also forms a part of the belt body. This results, on the endless belt thus produced, in a zone of unified material, which comprises the tensile member embedment, an adjoining belt body area therein and possibly a belt back area, this zone being a unified zone. There are no interfaces between the tensile member embedment and the bottommost belt back layer, or between the tensile strand embedment and the belt body, at which an increased tendency to rupture or cracking might occur due to strong tensile forces or shear forces during operation.

For performing the process under the conditions prevailing in the molding operation, the unified material (M2) must be so viscous that it can be pressed through the tensile member layer. This material may have particular mechanical characteristics which distinguish it from a belt body material for the outer layer. It may be a softer material, for example, which lends better dynamics and greater flexibility to the belt in its performance. By contrast, the material of the outer belt body layer M1 may be a relatively harder material with greater abrasion resistance.

Pressing a greater quantity of the M2 material, initially located on the rear side of the belt, through the tensile member layer allows the production of coarse profiles, such as the standard profiles PL and PM, for example, which could otherwise not be produced by the airbag process using high modulus cords. The material M2 is not only forced between the tensile members but over a certain period of time is continually transported through the tensile member layer. Due to the uniform, radially outward pressure of the bellows, the tensile members are placed under a uniform pressure, which stresses the entire layer uniformly outwards and positions them very precisely, concentrically in relation to the circumference. The tensile members are optimally embedded by the material M2 flowing round them.

The proportion of the material M2 which is pressed through the tensile members into the belt body area is preferably at least 5%, and in the case of small profiles this preferably amounts to as much as approximately 5 mm overall belt height and rib height up to approximately 2.5 mm (standard ribbed belt profiles up to PK). The proportion of the material M2 is preferably at least 30%, more preferably at least 50% in the case of larger ribbed V-belts from an overall belt height of approximately >5 mm and a rib width from approximately >2.5 mm (standard ribbed belt profiles PL, PM and above). The proportion of the material M2 may preferably be up to 90% (all specifications in % by volume), for the small profiles preferably up to 30%, for the large profiles preferably up to 70%, more preferably up to 90%.

Due to the profile geometry, the process according to the invention will lead to the material of the outer layer M1 always being deposited on the mold and to some extent lining the mold, whilst the material M2 pressed through follows this mold, that is to say it arches convexly towards to the individual ribs or teeth or into the wedge. This core formation by the belt material M2 inside the belt body behind the force-transmitting flanks has an advantageous effect on the mechanical characteristics of the finished belt. The effect is greater the higher the relative proportion of the material M2, and is most pronounced in the case of large profiles.

The material M1 is selected according to the intended purpose and among other things influences the mechanical characteristics of the belt to a large degree. The material M1 can be optimized with regard to the abrasion resistance and for a good coefficient of friction, for example, or for the presence of electrical conductivity.

As an embedded, softer material the material M2 ensures greater belt flexibility, thereby reducing the self-heating of the belt in operation and, in interaction with M1, improving the running characteristics and the mileage.

For the purposes of the invention low-elasticity tensile members are generally used. These are preferably high modulus tensile members. The high modulus tensile members may take the form of permeable flat structures, for example woven or non-woven fabric, allowing the material flow of M2, and are preferably used in the form of tensile member cords. The individual cords are preferably composed of twisted material threads laid to form cord. The tensile members are in each case preferably composed of carbon, aramid, steel, glass or PBO fibers (PBO=poly(para-phenylene-2.6-benzobisoxazol)). Further materials or fibers may be mixed in with these preferred materials. Fibers composed of the preferred materials may be twisted, interwoven or otherwise combined with other fibers,

The tensile member layer may be composed of individual strands. This may be a wound cord layer, for example. However, the tensile member layer may also be of a flat formation, for example in a preferably coarse textile structure, which allows the material M2 to pass through it. It may be advantageous, especially when the tensile member layer consists of individual strands, to cover it on one or both sides with a reticulated or latticed overlay. This may, where necessary, increase the accuracy of the positioning of the tensile members. The tensile member layer may also be composed of cords which have been stabilized by webs. Such cords are commercially available under the name “Multicord” for example. Here a cord assembly of warp threads is connected by weft threads, which form webs between the cord strands.

In preferred embodiments the belt materials M1 and M2 are vulcanizable rubber materials and the tensile member layer is composed of aramid or carbon reinforcing members.

In a development of the invention at least one further layer is applied to the layer of the belt material M2 facing the rear side of the belt, in order to the form the blank. This may be a further belt material or a film or textile overlay, for example. The additional layer may form a support function in the belt, especially if the underlying belt material M2 is particularly soft. The further layer, together with the remainder of the belt material M2 that is not pressed through, forms the belt back of the finish-molded belt. A textile or film overlay can also be applied externally to the belt in addition to this layer.

In preferred embodiments the volumetric ratio between the belt materials M1 and M2 is 10:90 to 95:5, more preferably 10:90 to 80:20. This means that a very large proportion of the belt body can be formed by the belt material M2 pressed through. The belt material M1 then forms only an outer layer lining the impressing mold, which covers the force-transmission zones on the finished belt. At the other extreme, however, the belt body also be formed largely from the material M1, provided that the material M2 extends beyond the pure cord embedding zone into the belt body.

Exceptionally, the belt materials M1 and M2 may be equal, the overall material then being a material M2 which must satisfy the conditions for a viscosity low enough to allow the material to press through the tensile members during the molding operation.

According to a first aspect of the invention at least the belt material M1 is a vulcanizable material, which vulcanizes in the vulcanization drum of the airbag process during the molding under heat and pressure. The material M2 may then likewise be a vulcanizable material or a thermoplastic or a thermoplastic elastomer.

It is especially preferred, however, if the belt materials M1 and M2 are both vulcanizable materials which differ in their characteristics. Both materials are then vulcanized during the molding under heat and pressure and bond together at their interface. It is advantageous for this purpose if the materials M1 and M2 belong to the same class of rubber or elastomer.

In preferred embodiments the material M2, for example, may be a soft, particularly elastic, firmly adhering rubber elastomer and the material M1 may be a harder rubber elastomer, which affords advantages with regard to abrasion, coefficient of friction and dimensional stability, for example.

In especially preferred embodiments of the invention the flow of the material M2 through the cord plane, for example, may be adjusted so that 10 to 90% of the belt body of materials M1 and M2 is composed of the material M2.

The object of the invention is further achieved by an endless force-transmission belt in the form of V-belt or ribbed V-belt, which is obtainable by the process according to the invention. An outstanding feature of the force-transmission belt according to the invention is that the material M2 embedding the tensile members additionally forms a part of the belt body which extends into the individual ribs or the wedge. The tensile member embedding material and the material extending into the belt body form a unified zone with no interface. In particular embodiments this zone may also comprise a part of the belt back. The zone composed of the blank material M2 is then an endless, seam-free layer having convex arches at the positions of the ribs or one convex arch in the direction of the wedge. The convex arching may be pronounced enough to form a core inside the ribs or the wedge. This is the case where the ratio of M1 to M2 is rather small, for example 10:90.

The preferred embodiments described for the process according to the invention are replicated in the finished belt product. For example, the volumetric ratios between the vulcanizates from the belt materials M1 and M2 of the blank again preferably assume the ratio of 10:90 to 95:5, more preferably 10:90 to 80:20. On the belt back a further layer composed, for example, of a further belt material M3, a thermoplastic material such as film or a textile, may overlie the vulcanized belt material M2. In general, a textile layer may additionally overlie the belt back composed of any number of layers.

It is also readily possible to cover the force-transmission side with a textile overlay. The back may likewise have an additional covering.

The force-transmission belt according to the invention contains the inelastic tensile members already specified above.

Further materials may be present inside the belt. For example, ground fibers may be worked into certain layers, and color codings may be applied etc. Between the belt materials M1 and M2, too, there may also be other layers present in addition to the tensile members. The layer for the outermost rib-side belt profile zone situated on the outside of the blank may be backed by further layers, or the layer for M1 may be replaced by multiple layers.

The belts according to the invention show an optimum price/performance ratio; they have good dynamic characteristics, good power transmission values, good running performances and less of a tendency to rupture and cracking.

The invention is explained in more detail below with reference to an exemplary embodiment in conjunction with the drawings.

In the drawing:

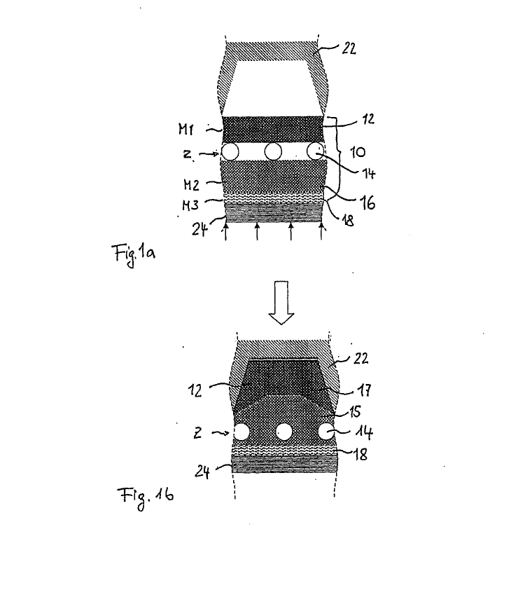

FIG. 1 shows the layer order of the blank in the impressing autoclave as a detail of a schematic cross sectional view—FIG. 1a after insertion, before impressing, FIG. 1b after applying pressure, pressed into the mold;

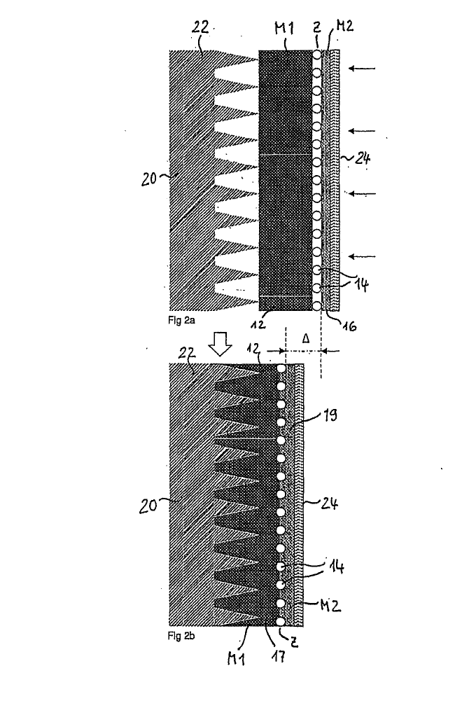

FIG. 2 shows a simplified sectional view from the vulcanizing autoclave wall and inserted blank—FIG. 2a before applying pressure, FIG. 2b after applying pressure in molded state—with a blank not according to the invention;

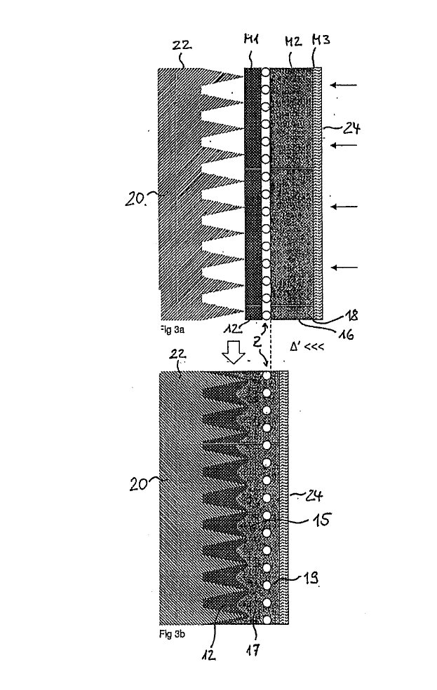

FIG. 3 shows a representation as in FIG. 2 with a blank according to the invention, again in FIG. 3a before impressing and in FIG. 3b after applying pressure in the molded state.

Each of the figures shows the inventive molding of a blank—in FIG. 2 not according to the invention—from the three basic layers: outer belt body layer M1, tensile member layer Z, belt back layer M2 (layer pressing through) and additional belt back layer M3. A ribbed V-belt is produced; in each case a detail is shown, in FIG. 1 only a rib. For the representation of the three steps in the process the materials do not matter. An example of the material structure is described below, however, under “Example”.

In FIG. 1a the blank 10 is inserted into a vulcanizing autoclave (not represented further) with the profiling drum 22 and the sleeve 24, which serves to deliver the impressing pressure. The blank, denoted overall by 10, is composed of the outer profile-side layer 12, which later will form the outermost layer of the belt body with the force-transmission zone, the tensile member layer Z with the individual, stranded tensile members 14, the layer 16, initially arranged on the rear side of the belt and pressing through during the molding, and the subsequent belt back layer 18. The arrows pointing towards the sleeve 24 indicate the pressure which is applied radially outwards from the inside of the drum 22 during the molding process. The blank is now deformed under heat and pressure, resulting in the pattern shown in FIG. 1b. The impressing pressure has pressed the layer 12 into the profiled recess of the drum 22, so that the material M1 of the layer 12 is available to the entire flank area and the force-transmission zone of the subsequent belt. In the heat the layer 16 has become sufficiently free-flowing, that is to say of a viscosity low enough to be pressed through the layer with the tensile members 14 under the pressure applied by the sleeve 24 during the molding process, so that it now adjoins the deformed layer 12 and forms a part of the belt body. The wedge or ribbed shape of the profile means that the layer 16, which follows the lining layer 12, forms a layer convexly arched towards the wedge or the rib, or a core within the wedge or the rib. In the example shown in FIG. 1 the belt material M2 is pressed through completely, so that at the end of the molding operation the belt back layer 18 comes to lie directly adjacent to the tensile member layer Z having the cords 14.

FIGS. 2 and 3 now show in more detail how the invention enables the inelastic tensile member layer to remain in its position during the molding operation.

FIG. 2 first shows a blank not according to the invention, the structure of which becomes clear from FIG. 2a. The blank in FIG. 2a is formed like a conventional blank having synthetic fiber tensile strands composed of polyamide or polyester, for example. The blank here comprises only three layers, that is to say the profile-side layer composed of the belt material M1, as layer 12, the tensile member layer Z with wound cord 14 and the layer composed of the belt material M2 applied to the belt back. During the molding process the sleeve 24, as indicated by the arrows in FIG. 2a, presses the entire blank radially outwards towards the profiling drum 22 of the vulcanizing autoclave 20. In so doing the whole material is moved outwards and the tensile strands 14, arranged relatively far away from the belt back, must also be stretched, as FIG. 2b illustrates. FIG. 2b shows the end state of the molding operation, in which the material M1 of the layer 12 has conformed to the profile of the drum 22 and in so doing has formed ribs. The material M2 now encloses the cord strands 14 and adjoins the material M1 of the layer 12. The materials M1 and M2 here may be identical, so that the layer 16 no longer appears independently. Rather, a unified belt material is then formed, in which the cord strands 14 are embedded. In this case the layer 16 is not pressed fully or not quite fully through the cord stand plane Z. Even if this were the case, with this blank geometry the cord stands would have to be stretched and displaced outwards during the impressing process. The degree of displacement is illustrated by means of the dashed lines, which indicate the cord stand plane Z: it can clearly be seen that this plane has been distinctly displaced by the molding, by the amount A compared to FIGS. 2a and 2b. The airbag molding process cannot therefore be used for the blank shown in FIG. 2, if inelastic cord strands are to be used.

The example according to the invention in FIG. 1 is again similarly shown in FIG. 3, revealing the particular advantages of the blank structure for the airbag process. Unlike the blank structure in FIG. 1, the profile-side layer on the tensile member layer Z comprises an outer layer 12 of the material M1 and an underlying layer 16′ of the material M2. This structure may be selected when an especially thin and yet uniform outer layer of the material M1 is to be formed on a belt body otherwise composed almost exclusively of the material M2. Alternatively, the layer 16′ might also be absent here, and the layer on the rear side of the tensile member layer could be formed correspondingly thicker. In addition, there is an additional layer 18 on the back of the belt, which here is formed from a vulcanizable elastomer material M3. Pressure is now again applied radially outwards by the sleeve 24 in the direction of the drum 22 of the vulcanizing autoclave 20. Impressing under heat and pressure leads to the end state as is shown in FIG. 3b. The layer 12 conforms to the profile of the drum 22; the layer 16 has for the most part been pressed through the tensile member layer Z, so that the layer 18 comes to lie directly on the tensile members, the material M2 embedding the tensile members without having been displaced by the material M3. The layer 16 forms a cohesive zone composed of the material M2, which in the shaped state connects the force-transmission zone to the tensile member area without any interface.

### Example Ribbed Belt Profile PL:

For the blank according to the invention the following structure may be given:

M1: CR (chloroprene rubber);
viscosity ML1+4/100° C.=approx. 45;
layer thickness approx. 1.2 mm
   M1: CR, ML1+4/100° C.=approx. 38;
layer thickness approx. 2.4 mm
   M3: woven fabric; thickness approx. 0.5 mm
   Volumetric ratio M1:M2=1:2

From the materials a belt blank, which corresponds to that shown in the figures, is wound on a building drum. In this example the cord is wound and introduced without any network layer.

The fabrication reel obtained after removal from the building drum is then introduced into a vulcanizing drum with suitable drum internal profile. A sleeve, which transmits the pressure applied by an air-filled bellows, is inserted into the inside of the tubular blank. The sleeve pressurized by the bellows presses the belt blank radially outwards into the heated vulcanizing drum. Under heating the molding process ensues as has been described with reference to the figures. Finally, vulcanization is performed under continuous heat.

For producing the specimen belt a vulcanizing autoclave made by Messrs. Eilhauer, Hanover, was used.

For further examples the aforementioned CR may be replaced, for example, by EPDM, BR, SBR or ACSM.

### LIST OF REFERENCE NUMERALS

10 blank
12 layer, outer, rib-side (M1)
14 tensile member
15 belt body area of M2
16 layer, rear-side (M2)
16′ layer (M2)
18 belt body
18 layer, belt back (M3)
19 belt back
20 vulcanizing autoclave
22 drum, profiled
24 sleeve (pressure application)
Z tensile member layer
M1 first belt material, outer belt body layer
M2 second belt material, pressed through, tensile member embedment and belt body core
M3 third belt material, belt back layer

1. A process for producing an endless V-belt or endless ribbed V-belt having low-elasticity tensile members in a molding process, comprising the steps of:
producing a tubular blank having at least two belt material layers and a layer of tensile members,
molding the tubular blank in a profiling drum under heat and pressure against a profile of the drum,
wherein a layer structure in the tubular blank from an outside inwards includes:
a) a layer of a belt material M1 as an outermost, rib-side belt profile zone of the belt body,
b) a layer of low-elasticity tensile members,
c) a layer of a belt material M2, which under molding conditions has a viscosity which is low enough for the belt material M2 to be pressed through spaces between the low-elasticity tensile members during the molding step, thereby forming a tensile member embedment, and
wherein the belt material M2 is present in the tubular blank in such a quantity and during the molding step is pressed through the spaces between the low-elasticity tensile members to such an extent that after the molding step some of the belt material M2 forms a belt body area inside a wedge or ribs.

2. The process as claimed in claim 1, wherein the low-elasticity tensile members are selected from the group consisting of high modulus tensile members composed of carbon, aramid, steel, glass or poly(para-phenylene-2.6-benzobisoxazol) (PBO).

3. The process as claimed in claim 1 wherein the layer of low elasticity tensile members is covered at least on one side by a reticulated or latticed overlay.

4. The process as claimed in claim 1, further comprising at least one further layer is applied to the layer of the belt material M2.

5. The process as claimed in claim 1 wherein a volumetric ratio between the belt materials M1 and M2 is from 10:90 to 95:5.

6. The process as claimed in claim 1, wherein at least the belt material M1 is a vulcanizable material which vulcanizes during the molding step under heat and pressure.

7. The process as claimed in claim 1, wherein the belt materials M1 and M2 are different vulcanizable materials, each of which vulcanize during the molding step under heat and pressure.

8. An endless force-transmission belt in the form of a V-belt or ribbed V-belt, obtained using the process as claimed in claim 1, wherein the material M2 embedding the low-elasticity tensile members additionally forms a belt body area, which extends into individual ribs or a wedge.
